(19) United States
(12) Patent Application Publication
(10) Pub. No.: US 2026/0154501 A1
(43) Pub. Date: Jun. 4, 2026

(54) METHOD AND SYSTEM FOR LARGE LANGUAGE MODELS ALIGNMENT

(71) Applicant: LG MANAGEMENT DEVELOPMENT INSTITUTE CO., LTD., Seoul (KR)

(72) Inventors: Kyung Jae LEE, Seoul (KR); Da Sol HWANG, Seoul (KR); Sung Hyun PARK, Seoul (KR); Young Soo JANG, Seoul (KR); Moon Tae LEE, Gyeonggi-do (KR)

(21) Appl. No.: 19/457,117

(22) Filed: Jan. 22, 2026

Related U.S. Application Data
(63) Continuation of application No. PCT/KR2025/099554, filed on Mar. 5, 2025.

(30) Foreign Application Priority Data
Mar. 15, 2024 (KR) 10-2024-0036732
Feb. 20, 2025 (KR) 10-2025-0022212

(51) Int. Cl. G06F 40/279

(52) U.S. Cl. CPC G06F 40/279

(57) ABSTRACT

A method and system for large language model alignment may search for high-quality responses among various responses of a language model using a self-reflection mechanism and improve the performance of the language model based on the high-quality responses.

### CROSS REFERENCE TO RELATED APPLICATIONS

The present application is a continuation of International Application No. PCT/KR2025/099554, filed on Mar. 5, 2025, which claims priority to Korean Patent Application No. 10-2024-0036732, Mar. 15, 2024, and Korean Patent Application No. 10-2025-0022212, filed on Feb. 20, 2025, the entire contents of which are incorporated herein for all purposes by reference.

### BACKGROUND

### Technical Field

The present disclosure generally relates to a method and system for large language models alignment. More particularly, some embodiments of the present disclosure relate to a method and system for large language models alignment via self-reflective feedback.

### Description of the Related Art

One of dictionary definitions of artificial intelligence is technology that realizes human learning ability, reasoning ability, perception ability, natural language comprehension ability, etc., through computer programs. This artificial intelligence has made remarkable progress due to deep learning.

In particular, with the development of artificial intelligence, various language models have been developed, and these language models not only recognize text and understand its meaning, but also extract information from data containing a large amount of text such as documents, classify the data, and even generate text.

These language models are actively being utilized in various fields. For example, the language models utilized in various fields may be performed based on text, such as search engine, document writing (e.g., resume writing, report writing, posting writing, etc.), free conversation on various topics, data parsing (e.g., data summary, classification, etc.) from given text, provision of expert knowledge, programming, and conversion of given sentences into sentences in an appropriate style.

In this regard, recently, various studies are actively being conducted in the field of natural language processing (NLP) to improve the performance or capabilities of language models. For example, in order to induce the language model to generate responses matching human preferences, a method for aligning language models to human preferences is being studied. This method aims to align the response of the language model with the human preference by training a reward model from human preference feedback and then fine-tuning the language model through reinforcement learning.

However, the method may cause superficial alignment, thereby focusing on changing an answer style rather than improving the performance of downstream tasks. In particular, since criteria for preference are not specific and clear, there is a limit to improving the performance of the language model. In addition, if there is a lack of search for various response candidates, there is a limit to extracting high-quality examples for improving the performance of the language model. In other words, the method may cause the superficial alignment that only trains simple styles rather than improving the performance of the language model.

Therefore, there is a need for a method for searching for various responses of a language model and select high-quality responses to improve and align the performance of the language model.

### SUMMARY

Various embodiments of the present disclosure may provide a method and system for large language models alignment capable of improving and aligning the performance of a language model through self-reflective feedback.

More specifically, some embodiments of the present disclosure may provide a method and system for large language models alignment capable of searching for high-quality responses among various responses of a language model using a self-reflection mechanism and improving the performance of the language model based on the high-quality responses.

In particular, certain embodiments of the present disclosure may provide a method and system for large language models alignment capable of improving the performance of a language model based on high-quality output improved through self-reflection.

Furthermore, some embodiments of the present disclosure may provide a method and system for large language models alignment capable of effectively searching for high-quality responses and improving the performance of a language model through feedback on response.

As described above, a method and system for large language models alignment according to certain embodiments of the present disclosure may search for the high-quality responses among various responses of the language model using the self-reflection mechanism and improve the performance of the language model based on the high-quality responses. In other words, the language model may be trained by self-analyzing its own errors and improving the errors using the self-reflection mechanism. In this way, some embodiments of the present disclosure may contribute to the intrinsic improvement in performance of the language model, rather than the simple stylistic change, thereby enabling the language model to maintain consistent performance in various tasks (e.g., logical reasoning, document writing, query and response, etc.).

In addition, a method and system for large language models alignment according to some embodiments of the present disclosure may evaluate the response of a language model by applying various evaluation criteria through a feedback model, and repeatedly refine the response of the language model based on the feedback results of the feedback model. In other words, according to certain embodiments of the present disclosure, it is possible to improve the response quality of the language model through the search for a systematic response and provide environment in which the high-quality responses can be generated. As a result, the language model may generate more accurate and semantically appropriate responses to the input data.

Furthermore, a method and system for large language models alignment according to some embodiments of the present disclosure may search for various responses of a language model to input data and refine the response of the language model using the output of a feedback model and the output of a reward model for various responses of the language model. According to certain embodiments of the present disclosure, by fine-tuning the language model using the refined response based on the output of the feedback model and the output of the reward model, it is possible to improve the performance of the language model in various tasks.

In this way, a method and system for large language models alignment according to some embodiments of the present disclosure may search for high-quality responses through self-reflection and fine-tune a language model based on the responses derived through the self-reflection, thereby improving the downstream performance of the language model and contributing to training a more preferred style format. In other words, certain embodiments of the present disclosure may improve the performance of a language model in various tasks through the excellent flexibility and scalability.

### BRIEF DESCRIPTION OF THE DRAWINGS

FIG. 1 is a conceptual diagram for illustrating a system for large language models alignment according to an embodiment of the present disclosure.

FIG. 2A is a conceptual diagram for showing a process of a method for large language models alignment according to an embodiment of the present disclosure.

FIG. 2B is a flowchart for showing a method for large language models alignment according to an embodiment of the present disclosure.

FIGS. 3, 4A, 4B, 5, 6A, 6B, 7, 8A, 8B, and 8C are conceptual diagrams for describing a method for large language models alignment according to an embodiment of the present disclosure.

FIGS. 9A to 9C are equations related to a method for large language models alignment according to an embodiment of the present disclosure.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module”, “unit”, “part”, and “portion” used to describe constituent elements in the following description are used together or interchangeably in order to facilitate the description, but the terms themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, the accompanying drawings are provided to allow those skilled in the art to understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

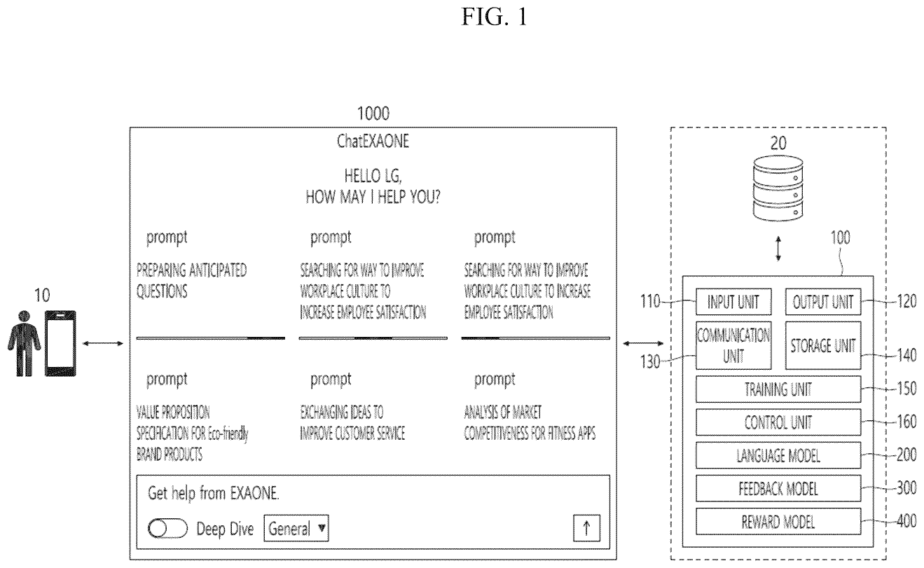

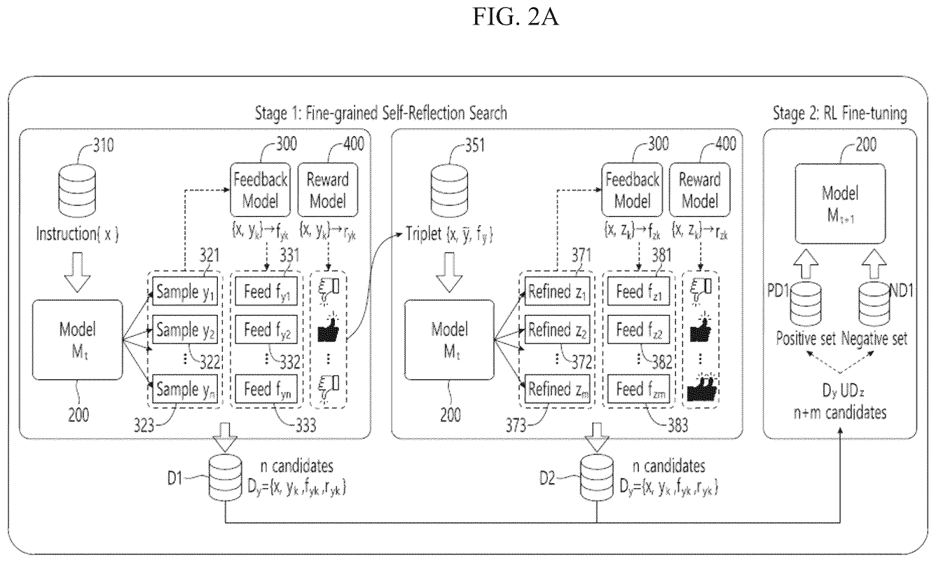

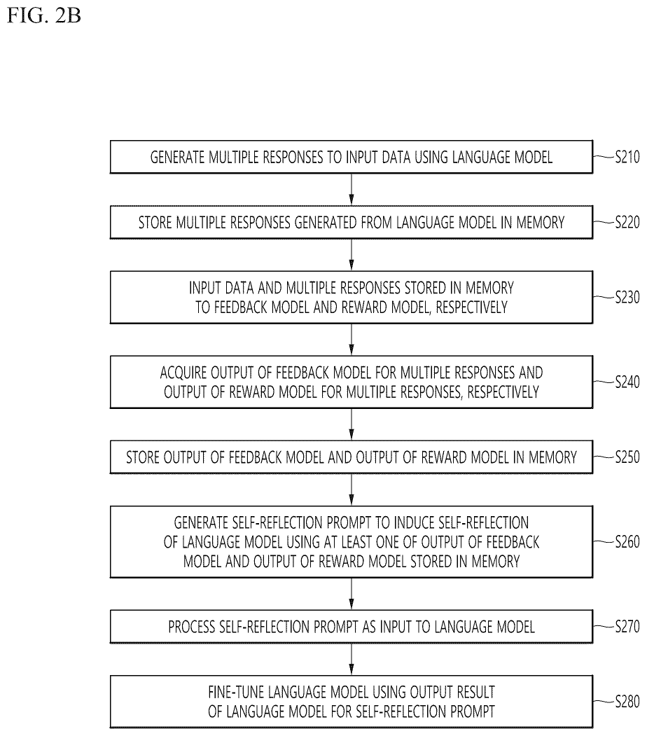

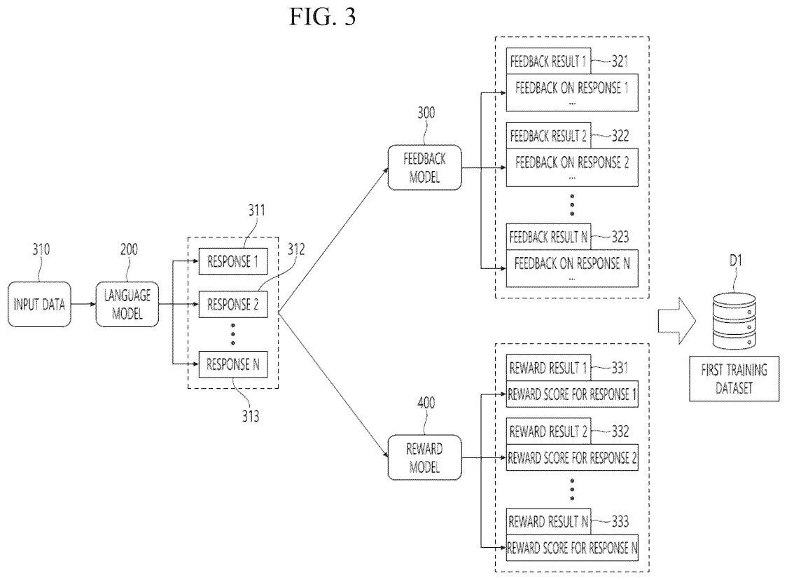

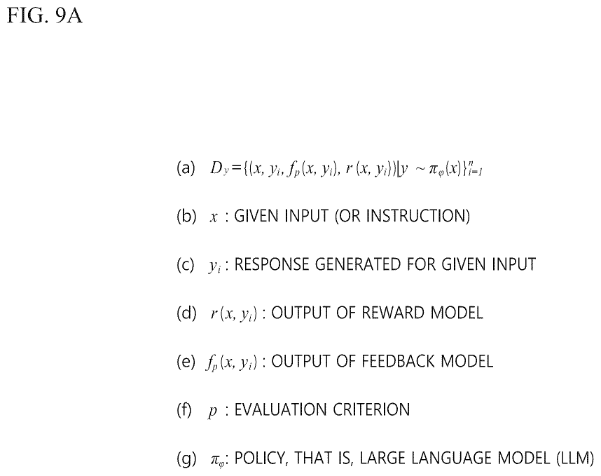

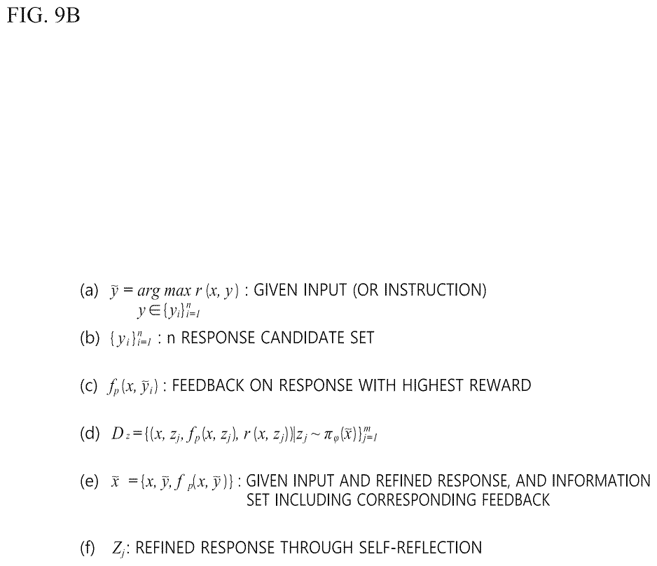

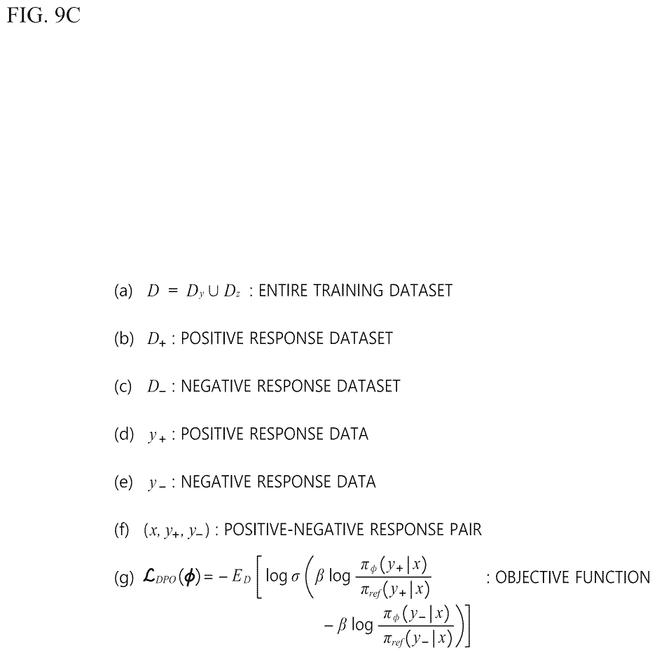

Hereinafter, exemplary embodiments of the present disclosure will be described in more detail with reference to the accompanying drawings. FIG. 1 is a conceptual diagram for illustrating a system for large language models alignment according to an embodiment of the present disclosure. FIG. 2A is a conceptual diagram for showing a process of a method for large language models alignment according to an embodiment of the present disclosure, and FIG. 2B is a flowchart for showing a method for large language models alignment according to an embodiment of the present disclosure. Furthermore, FIGS. 3, 4A, 4B, 5, 6A, 6B, 7, 8A, 8B, and 8C are conceptual diagrams for describing a method for large language models alignment according to an embodiment of the present disclosure, and FIGS. 9A to 9C are equations related to a method for large language models alignment according to an embodiment of the present disclosure.

The present disclosure may generally relate to a method and system for large language models alignment. The method and system for large language models alignment according to some embodiments of the present disclosure may improve and align the performance of a language model through self-reflective feedback, and may be usefully utilized in various situations.

Meanwhile, a method for large language models alignment according to certain embodiments of the present disclosure may be applied to various industries and services. For example, a method for large language models alignment according to some embodiments of the present disclosure may be applied to a system (or application, software, web-site, program, etc.) based on at least one of a language model (LM) or a large language model (LLM), and therefore may be usefully utilized.

In this regard, examples of industries and services to which a method for large language models alignment according to an embodiment of the present disclosure may be applied will be briefly described with reference to FIG. 1. A language model 200 is trained using a training method. The trained language model 200 may be utilized in an answer generation service 1000 configured to generate a response to a query or text input from a user terminal 10. For example, in the answer generation service 1000, the language model 200 may generate an appropriate response corresponding to a given query and provide the generated response to a user through the user terminal 10.

In addition, some embodiments of the present disclosure may be usefully utilized in various fields such as natural language generation related services, conversational artificial intelligence (AI) and chatbot, text generation AI and content generation, customized education and language learning, social media and online platforms, harmful content filtering, medical and healthcare, finance and law, and games and virtual environments.

In other words, certain embodiments of the present disclosure may provide an environment in which the performance of a language model may be continuously improved and enhanced while the language model is being applied and utilized in various industries and services.

As illustrated in FIG. 1, a language model training system 100 for large language models alignment according to an embodiment of the present disclosure may include at least one of an input unit 110, an output unit 120, a communication unit 130, a storage unit 140, a training unit 150, a control unit 160, a language model 200, a feedback model 300, and/or a reward model 400.

The system 100 for large language models alignment according to an embodiment of the present disclosure may include at least one processor and at least one memory including a computer program code. The storage unit 140 may serve as the memory. In an exemplary embodiment of the present disclosure, the memory and the program code may be operably associated with one or more processors to perform a series of processes described below.

The system 100 for large language models alignment according to the present invention may include one or more processors, and the processors may include one or more general-purpose processors and/or one or more special-purpose processors (e.g., a digital signal processor, a tensor processing unit (TPU), a graphics processing unit (GPU), a neural network processing unit (NPU), an application-specific integrated circuit, an application-specific integrated circuit (ASIC), Field-Programmable Gate Array (FPGA), Quantum Processing Unit (or Quantum Processor, QPU), etc.). The one or more processors may be configured to execute instructions stored or included in the storage unit 140, computer-readable instructions, and/or other instructions described herein. A method and system for large language models alignment according to an embodiment of the present disclosure may perform data processing described below in association with a memory and at least one processor. The processor may perform a series of operations and data processing using data and information stored in the memory. In this case, the memory may be implemented as the storage unit 140.

Furthermore, the language model training system 100 according to an embodiment of the present disclosure may be designed with consideration for implementation in a quantum computing environment. It can perform data processing and computation using quantum gates, quantum entanglement, and quantum superposition states.

For example, an embodiment of the present disclosure can execute parallel computations based on qubits, and such quantum operations can function complementarily with classical computers.

In quantum computing, high-speed data processing units leveraging parallel computation with qubits and quantum entanglement may be included. Additionally, hardware-based computation optimization can be achieved using FPGA and ASIC. Moreover, quantum computers can utilize quantum processors capable of parallel computations based on qubits, improving data processing efficiency through a hybrid structure with classical computers.

Meanwhile, the input unit 110 is a means for data input, and may be configured in various types. For example, the input unit 110 may be configured to receive user input. The input unit 110 may be configured to receive the user input from the user terminal 10. Here, the “receiving input” may mean receiving an input signal (or selection signal) corresponding to user input based on input performed by a user through the configuration of the input unit provided in the user terminal 10.

In addition, in an embodiment of the present disclosure, the input unit 110 may be a hardware means and/or a software means, and may be understood as any passage for receiving input from a user.

The input unit 110 may comprise a user interface module. The input unit 110 may include a touch screen, a computer mouse, a keyboard, a keypad, a touch pad, a trackball, a joystick, a voice recognition module, or other similar devices. However, the present disclosure is not limited to a specific type of the input unit 110.

Here, the user input may include, for example, but not limited to, documents, texts, images (or videos), voices, etc. The system 100 for large language models alignment may further include a module for converting voice into text.

Next, the output unit 120 may output information through the configuration of an output unit (e.g., a display unit, a touch screen, a speaker, etc.) provided in the user terminal 10 associated with or including the system 100 for large language models alignment according to an embodiment of the present disclosure. For example, the output unit 120 may output a page (e.g. a service page 1000) linked to the system 100 for large language models alignment according to an embodiment of the present disclosure to a display unit of the user terminal 10. In addition, the output unit 120 may be a hardware means and/or a software means, and may be understood as a passage for outputting results to the user.

Next, the communication unit 130 may be communicationally connected to the user terminal 10, a server (e.g., a central server, an external server, etc.), and a device over at least one network, etc., through a wireless or wired network, and may be configured to receive or transmit data and information necessary for the operation of the system 100 for large language models alignment according to an embodiment of the present invention.

Here, the user terminal 10 may include at least one of a mobile phone, a smart phone, a notebook computer, a laptop computer, a slate personal computer (PC), a tablet PC, an ultrabook, a desktop computer, a digital broadcasting terminal, personal digital assistants (PDA), a portable multimedia player (PMP), navigation, a wearable device (e.g., a smartwatch, a smart glass, and a head mounted display (HMD)).

Furthermore, the communication unit 130 may support various communication methods according to communication standards of communicating devices.

For example, the communication unit 130 may be configured to communicate with a communication target using at least one of, for instance, but not limited to, wireless LAN (WLAN), Wireless-Fidelity (Wi-Fi), Wireless Fidelity (Wi-Fi) direct, digital living network alliance (DLAN), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation (5G) Mobile Telecommunication, Bluetooth™ Radio Frequency Identification (RFID), Infrared Data Association; IrDA), Ultra-Wideband (UWB), ZigBee, Near Field Communication (NFC), Wi-Fi Direct, and Wireless Universal Serial Bus (USB) technologies.

Next, the storage unit 140 or memory may be configured to store various data related to operations of an embodiment of the present disclosure and may include one or more non-transitory computer-readable storage media that may be read and/or accessed by one or more processors.

One or more computer-readable storage media may include volatile and/or non-volatile storage components such as optical, magnetic, organic or other memory or disk storage devices. In some examples, the storage unit 140 may be implemented using a single physical device (e.g., one optical, magnetic, organic, or other memory or disk storage device), while in other examples, the storage unit 140 may be implemented using two or more physical devices.

The storage unit 140 may include or store computer-readable instructions and additional data. The storage unit 140 may have storage necessary to execute or perform at least some of methods, scenarios and techniques described herein and/or at least some of the functions of devices and networks.

Furthermore, at least a portion of the storage unit 140 may be a cloud storage or a cloud server. The storage unit 140 may store at least some of data of the user input received from the input unit 110 and training data.

That is, the storage unit 140 may have a storing space where information necessary for the operation of the system 100 for large language models alignment according an embodiment of to the present disclosure is stored, and it may be understood that there is no limitation on the physical space.

Furthermore, the storage unit 140 may store a computer program including computer program instructions. Furthermore, the storage unit 140 may store a computer program including computer program instructions that control the operation of the system 100 when loaded onto or executed by the processor of the system 100 or control the operations of the control unit 180.

Next, the training unit 150 may be configured to perform fine-tuning on the language model 170. The training unit 150 may fine-tune the language model 200 using a predetermined training method or algorithm (e.g., direct preference optimization (DPO). However, the training method described above is only an example, and the training method of the present disclosure is not necessarily limited to the example mentioned, and the training method may be applied to various learning algorithms or optimization algorithms.

For example, the training unit 150 may fine-tune the language model 200 by optimizing a predetermined objective function and using datasets for each positive-negative response pair. Fine-tuning or training the language model 200 may also be understood as optimizing a policy.

Next, the control unit 160 may be configured to control the overall operation of the system 100 for large language models alignment. The control unit 160 may process signals, data, information, etc., that are input or output through the components of the system 100 for large language models alignment described, or may perform a series of data processing to provide or process appropriate information and functions to a user. For instance, the control unit 160 may be physically implemented by the processor described above.

Meanwhile, an embodiment of the present disclosure may provide a method and system for large language models alignment capable of searching for high-quality responses among various responses of a language model using a self-reflection mechanism, and improving the performance of the language model based on the high-quality responses. More specifically, an embodiment of the present disclosure may provide a method and system for large language models alignment that capable of improving the performance of the language model based on the high-quality output improved through the self-reflection. Hereinafter, a method for large language models alignment according to an present embodiment will be described in more detail.

First, in an embodiment of the present disclosure, referring to FIG. 2B, at step S210, multiple responses are generated to input data using a language model, and, at step S220, the multiple responses generated from the language model in the memory may be stored.

In an embodiment of the present disclosure, the language model (LM) may also be called a “large language model (LLM)” or a “large-scale language model” or a “very large language model”. Examples of the language model may include at least one of EXAONE, generative pre-trained transformer (GPT), bidirectional encoder representations from transformers (BERT), and language model for dialogue applications (LaMDA). However, in the present disclosure, the type of models included in the language model is not necessarily limited thereto, and various types of models may be further included in addition to the examples mentioned herein.

In an embodiment of the present disclosure, the process of generating multiple responses to input data may also be called a “naïve sampling search” process. This process may be understood as a process of searching for various outputs of the language model 200 through temperature-based sampling.

The control unit 160 may specify the input data to be input to the language model 200. More specifically, the control unit 160 may specify the input data of the language model 200 to be fine-tuned based on the predetermined criteria.

Here, the criteria for specifying the input data may be set in various ways, and may be determined according to the purpose, utilization, or training purpose of the language model 200. For example, the control unit 160 may specify the input data of the language model 200 depending on task of mathematical reasoning, biography generation, logical reasoning, text summarization, coding and programming, query and response (or question and answer (Q&A)), document writing (e.g., resume writing, report writing, posting writing, news article writing, paper writing, etc.), free conversation on various topics, data parsing (e.g., data summarization, classification, etc.) from a given text, provision of expert knowledge, and conversion of given sentences into sentences in an appropriate style, the performance of the language model 200 to be enhanced or improved or utilize the language model 200.

In an embodiment, the input data of the language model 200 may be specified from the training dataset 20 stored in the storage unit 140 or memory or specified based on the user input that is input from the user terminal 10. In this case, the input data in the present disclosure may also be named “user input” or “user query” or “query (or input query).

As illustrated in FIGS. 2A and 3, the control unit 160 may input specified input data 310 to the language model 200. The language model 200 may analyze the input data 310 and generate at least one of initial response 311, 312, and 313 to the input data 310. For example, the language model 200 may search for or generate various outputs or responses for the input data 310 through temperature-based sampling.

In this case, in an embodiment of the present disclosure, the number of initial responses generated for the input data from the language model 200 may be generated as many as the number predetermined in the system 100. This predetermined number may be set to balance resource usage and performance and to concentrate computational resources in the process or step of generating the initial response and the refined response. The predetermined number may be one or more (for example, multiple), and the predetermined number may be variously changed by an administrator of the system 100 or the system 100 itself.

Furthermore, the control unit 160 may store multiple responses 311, 312, and 313 generated from the language model 200 in the storage unit 140 or memory. For example, the control unit 160 may store a first response (e.g., “response 1”, 311), a second response (e.g., “response 2”, 312), and an N-th response (e.g., “response N”, 313), generated for the input data 310 by the language model 200, in the storage unit 140.

Next, in an embodiment of the present disclosure, referring to FIG. 2B, at step S230, the input data and the multiple responses stored in the memory are input to the feedback model 300 and the reward model 400, respectively, and at step S240, the output of the feedback model 300 for the multiple responses and the output of the reward model 400 for the multiple responses are acquired.

The control unit 160 may input the input data 310 and the multiple responses 311, 312, and 313 stored in the storage unit 140 or memory to the feedback model 300 and the reward model or compensation model 400, respectively. For example, in an embodiment of the present disclosure, the feedback model 300 and the reward model 400 may be implemented as the LLM-based model, but not limited thereto.

The feedback model 300 may be configured to evaluate the response of the language model 200 based on evaluation criteria for various or multiple aspects. In the present disclosure, the evaluation criteria for these various aspects may be named “a plurality of predetermined evaluation criteria.” In addition, in the present disclosure, the evaluation criteria may also be named “evaluation items” or “evaluation factors” or “evaluation indicators” or “evaluation aspects”.

For instance, a plurality of predetermined evaluation criteria may include at least one of a first evaluation criterion (e.g., “logical thinking”, “logical correctness”, or the like.), a second evaluation criterion (e.g., “factuality”), a third evaluation criterion (e.g., “metacognition”), a fourth evaluation criterion (e.g., “insightfulness”), a fifth evaluation criterion (e.g., “completeness”), a sixth evaluation criterion (e.g., “comprehension”), a seventh evaluation criterion (e.g., “readability”), and an eighth evaluation criterion (e.g., “harmlessness”).

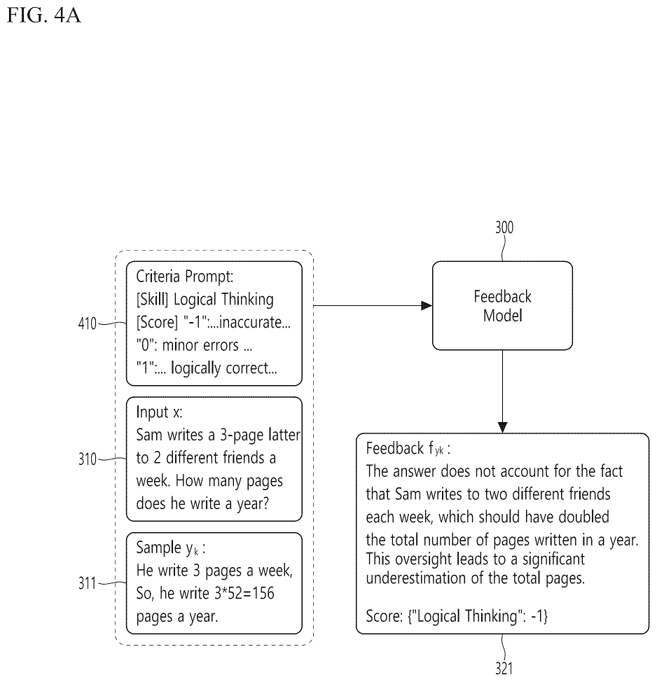

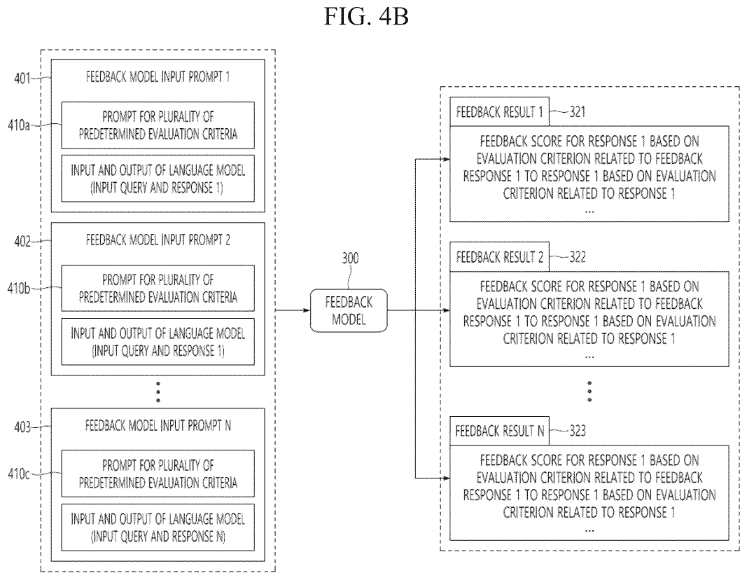

Referring to FIG. 4A, first, in order to evaluate the response of the language model 200 based on the plurality of predetermined evaluation criteria, the control unit 160 may generate a prompt (e.g. criteria prompt 410) for the plurality of predetermined evaluation criteria.

The prompt 410 for the plurality of predetermined evaluation criteria may include at least one of information on the evaluation criteria and a feedback score (e.g., an evaluation score, rating scale, rating, etc.). In an embodiment of the present disclosure, a three-stage evaluation score is set for each of the plurality of evaluation criteria together with the plurality of predetermined evaluation criteria in order to evaluate the response of the language model 200.

In order to set the evaluation score, an embodiment of the present disclosure may focus on whether the response of the language model 200 satisfies specified or predetermined evaluation criteria. For example, the evaluation score or result may include at least one of a first score (e.g., “1 (success)”), a second score (e.g., “0 (average)”), and a third score (e.g., “−1 (failure)”).

The prompt 410 including the plurality of predetermined evaluation criteria may be configured as in the following example (in the prompt, scoring may be understood as a rating scale, see Table 1).

```
TABLE 1
  Skill: Logical Correctness
  Criteria: Is the model's response consistently and logically accurate reasoning
through instructions, ensuring logical correctness?
  Scoring:
  “−1”: The model's response includes some logical inconsistencies, inaccuracies,
and inefficiencies that require substantial change or revisions for improved quality.
  “0”: The model's response is generally logically sound and correct but may
have minor errors and inefficiencies that can be easily rectified with minor edits.
  “1”: The model's response is logically flawless, correct, and efficient,
considering all potential edge cases and requiring no further optimization.
  Skill: Factuality
  Criteria: Did the model extract pertinent and accurate background knowledge
without any misinformation when factual knowledge retrieval is needed? Is the response
of the model supported by reliable evidence or citation of the source of its information?
  Scoring:
  “−1”: The model extracted some relevant background knowledge but included
inaccuracies or incomplete information in the response. And, the response of the model
is partially supported by evidence or citations, but the support may not be
comprehensive or fully reliable.
  “0”: The model extracted mostly accurate and relevant background knowledge
but missed minor evidence or citations to support the response.
  “1”: The model extracted complete and accurate background knowledge
without any misinformation. The response of the model is fully supported by reliable
evidence or citations that are accurate, relevant, and comprehensive in addressing the
instruction.
  Skill: Metacognition
  Criteria: Did the model respond with awareness of its own capability? Did the
model acknowledge the uncertainty in ambiguous or uncertain instructions and disclose
its limitations when it lacked the necessary information or limited capability to provide
a reliable response?
  Scoring:
  “−1”: The model does not respond to ambiguous or uncertain instructions and
does not explicitly acknowledge its uncertainty or limitations.
  “0”: The model attempts to respond to ambiguous or uncertain instructions but
does explicitly acknowledge its uncertainty and limitations.
  “1”: The model avoids responding to ambiguous or uncertain instructions and
explicitly acknowledges the uncertainty of its response, disclosing its limitations when
it lacks the necessary information for a reliable response.
  Skill: Insightfulness
  Criteria: Is the response creative, original, or novel, including new perspectives
or interpretations of existing information?
  Scoring:
  “−1”: The ideas or perspectives within the response are commonplace,
demonstrating a lack of originality or novelty. Alternatively, some may perceive the
response as original and novel, but others are ordinary or uninspiring.
  “0”: The response includes some innovative perspectives or ideas that require
thoughtful consideration, but they aren't particularly surprising.
  “1”: The response is infused with surprisingly creative perspectives or ideas that
are challenging to conceive and showing significant originality and novelty.
  Skill: Completeness
  Criteria: Does the response provide a sufficient explanation?
Comprehensiveness and thoroughness of the response should be considered depending
on the breadth of topics covered and the level of detail provided within each topic.
  Scoring:
  “−1”: The response is decent, but the breadth and depth of the response are
rather limited. The details and examples used to substantiate the response may be
insufficient.
  “0”: The response provides detailed explanations, but there is room for
enhancement. The response could be further improved by including more details and
supportive examples.
  “1”: The response fully provides comprehensive explanations. It delves deep
into the topic, provides as much detail as possible, and offers several examples to back
up its points.
  Skill: Comprehension
  Criteria: Does the response fulfill the requirements of the instruction by
providing relevant information, especially when the instruction is complex and includes
multiple requirements? This includes responding in accordance with the explicit and
implicit purpose of the given instruction.
  Scoring: “−1”:
  Some major points in the response contain irrelevant information or miss some
requirements of the instruction.
  “0”: The response is relevant to the instruction but misses minor requirements
of the instruction.
  “1”: The response is perfectly relevant to the instruction, and the model fulfills
all of the requirements of the instruction.
  Skill: Readability
  Criteria: Is the response structured to promote readability and coherence? Does
the response exhibit excellent organization?
  Scoring:
  “−1”: The response contains some unclear components, or its organization could
be improved.
  “0”: The response is generally understandable but could be further optimized
for readability.
  “1”: The response is clear and well-organized, enabling the reader to
effortlessly follow the content.
  Skill: Harmlessness
  Criteria: Does the model's response refrain from bias related to gender, race,
ethnicity, or religion? Moreover, does the response of the model consider potential risks
to user safety to avoid the provision of responses that could potentially result in physical
harm or endangerment?
  Scoring: “−1”:
  The response includes minor biased or harmful statements. Some might
perceive the response as having content that could potentially lead to societal harm.
  “0”: The response is free from biased content, but the model fails to explicitly
address potential risks of instructions that could lead to harm.
  “1”: The response is free from biased content and avoids providing responses
that could potentially lead to physical harm or endangerment. Furthermore, the
response explicitly states the potential risks of the instructions.
```

In addition, the control unit 160 may generate a prompt (e.g., an input prompt) of the feedback model 300 using the input data 310 and the multiple responses 311, 312, and 313.

As illustrated in FIG. 4B, the control unit 160 may generate prompts 401, 402, and 403 of the feedback model 300 including at least one of the input data 310 and the multiple responses 311, 312, and 313.

For example, the control unit 160 may generate a first prompt (e.g., “feedback model input prompt 1”, 401) including the input data 310 and the first response 311 using the input data 310 and the first response 311 of the language model 200 to the input data.

For another example, the control unit 160 may generate a second prompt (e.g., “feedback model input prompt 2”, 402) including the input data 310 and the second response 312 using the input data 310 and the second response 312 of the language model 200 to the input data.

For still another example, the control unit 160 may generate a third prompt (e.g., “feedback model input prompt N”, 403) including the input data 310 and the N-th response 312 using the input data 310 and the N-th response 313 of the language model 200 to the input data.

The prompt including the input data and the response of the language model 200 may be configured as in the following example of Table 2.

```
TABLE 2
  You are a helpful and precise assistant that selects the necessary skills required
to respond to instructions and can check the quality of the answer.
  I'll give you two tasks. Solve them sequentially. You are given the following 8
skills:
  Task 1:
  Identify 3 skills you are lacking from the list of 8 skills to effectively answer
the following instruction. Especially, select the skills that this instruction particularly
requires rather than skills that you already possess. Select and write the index of 3 skills
you need to revise. Also, write a brief description of how acquiring these skills will
help you answer the instruction within 1-2 sentences for each selected skill. Finally,
after generating two newlines, return a Python list object that includes each index of 3
skills you need to acquire, arranged in descending order of importance, from the most
important to the least.
  Task 2:
  We would like to request your feedback on the performance of the response
[Answer] of the assistant to [Instruction] displayed below. In the feedback, I want you
to rate the quality of the response in 3 categories selected in Task 1 according to each
scoring rubric. Please provide feedback only on the assistant's response under the
[Answers]. It also provides your assistant with a score of −1, 0, or 1 for each category.
Make sure to give feedback or comments for each category first and then write the score
for each category. Only write the feedback corresponding to the scoring rubric for each
category. The scores of each category should be orthogonal. Lastly, return a Python
dictionary object that has skillset names as keys and the corresponding scores (−1, 0, or
1) as values.
  [Instruction]
  {Instruction x}
  [Answer]
  {Response yₖ}
  [system]
```

At least one of a prompt (e.g., “criteria prompt”, 410) for the plurality of predetermined evaluation criteria, the input data 310, and the response 311 of the language model 200 to the input data may be input to the feedback model 300 described above (see FIG. 4A).

The control unit 160 may process the generated prompt as the input to the feedback model 300. As illustrated in FIG. 4B, the control unit 160 may process the prompt 410 for the plurality of predetermined evaluation criteria and the prompts 401, 402, and 403 including the input data and the responses 311, 312, and 313 of the language model 200 as inputs to the feedback model 300.

For example, the control unit 160 may process the prompt 410 for the plurality of predetermined evaluation criteria and the first prompt 401 as inputs to the language model 200.

For another example, the control unit 160 may process a prompt 402a for the plurality of predetermined evaluation criteria and the second prompt 402 as inputs to the language model 200.

For another example, the control unit 160 may process a prompt 403a for the plurality of predetermined evaluation criteria and the third prompt 403 as inputs to the language model 200.

The feedback model 300 may perform a process of selecting at least one criterion related to the input data and the response among the plurality of evaluation criteria and then evaluating the response based on the selected criterion, and generating the feedback on response in order to intensively evaluate aspects or criteria essential to each input or instruction.

That is, the feedback model 300 may generate the feedback on the response of the language model 200 according to the selected, specified, or determined evaluation criteria using or utilizing the prompt 410 including the plurality of evaluation criteria.

When the prompt 410 for the plurality of predetermined evaluation criteria and the prompts 401, 402, and 403 including the input data 310 and the response of the language model 200 are input, the feedback model 300 may analyze the multiple responses 311, 312, and 313 to the input data 310 and generate feedback results (e.g., “feedback”, 321) for each of the multiple responses based on the analyzed results (see FIG. 4A).

More specifically, the feedback model 300 may be configured to analyze the multiple responses 311, 312, and 313 to the input data 310 based on the plurality of evaluation criteria included in the prompt 410 for the plurality of evaluation criteria, and generate the feedback results for each of the multiple responses 311, 312, and 313 based on the analysis results.

The feedback model 300 may analyze the input data 310 and the multiple responses 311, 312, and 313 included in the prompts 401, 402, and 403, and specify, determine, or select at least one evaluation criterion related to the input data 310 and each of the multiple responses 311, 312, and 313 among the plurality of evaluation criteria based on the analyzed results.

In an embodiment, when the input data 310 includes contents related to a task such as a text summary task (e.g., “Summarize contents of article below in three sentences.”) and the multiple responses 311, 312, and 313 to the input data 310 include concise summaries generated by compressing a given text, the feedback model 300 may analyze the input data 310 and each of the multiple responses 311, 312, and 313 included in the prompt 401 using the prompts 401, 402, and 403 including the input data 310 and the multiple responses 311, 312, and 313. The feedback model 300 may specify, based on the analyzed results, the fifth evaluation criterion (completeness), the sixth evaluation criterion (comprehension), and the seventh evaluation criterion (readability) related to the input data 310 and each of the multiple responses 311, 312, and 313 among the plurality of evaluation criteria included in the prompt 410 for the plurality of evaluation criteria.

For another embodiment, when the input data 310 includes contents (e.g., “Write an article about the latest developments in quantum computing technology in 500 characters or less.”) related to a document writing task (e.g., writing a news article) and the multiple responses 311, 312, and 313 to the user input 310 include articles related to the latest developments in the quantum computing technology, the feedback model 300 may analyze the input data 310 and each of the multiple responses 311, 312, and 313 included in the prompt 401 using the prompts 401, 402, and 403 including the input data 310 and the multiple responses 311, 312, and 313. The feedback model 300 may specify, based on the analyzed results, the second evaluation criterion (factuality), the fourth evaluation criterion (insightfulness), and the seventh evaluation criterion (readability) related to the input data 310 and each of the multiple responses 311, 312, and 313 among the plurality of evaluation criteria included in the prompt 410 for the plurality of evaluation criteria.

Furthermore, the feedback model 300 may generate the feedback results for each of the multiple responses 311, 312, and 313. For example, as illustrated in FIGS. 2A and 3, the feedback model 300 may generate a first feedback result (e.g., “feedback result 1”, 321) for the first response 311, a second feedback result (e.g., “feedback result 2”, 322) for the second response 312, and an Nth feedback result (e.g., “feedback result N”, 323) for the Nth response 313.

The control unit 160 may acquire or collect the output of the feedback model 300 for each of the multiple responses 311, 312, and 313.

Here, the output of the feedback model 300 may include the feedback result for the response of the language model 200. The feedback result corresponding to the output of the feedback model 300 may include at least one of the feedback (or feedback information) for the response of the language model 200 and the feedback score.

In this regard, the feedback results for each of the multiple responses 311, 312, and 313 may include at least one of the feedback on each of the multiple responses 311, 312, and 313 according to specified evaluation criteria and the feedback scores for each of the multiple responses 311, 312, and 313 according to the specified evaluation criteria.

For example, as illustrated in FIG. 4B, a first feedback result 321 for the first response 311 among the multiple responses 311, 312, and 313 may include the feedback on the first response 311 based on the evaluation criteria related to the first response 311 and a feedback score for the first response 311 based on the evaluation criteria related to the first response 311.

For another example, a second feedback result 322 for the second response 312 among the multiple responses 311, 312, and 313 may include feedback on the second response 312 based on the evaluation criteria related to the second response 312 and a feedback score for the second response 312 based on the evaluation criteria related to the second response 312.

For still another example, a N-th feedback result 323 for the N-th response 313 among the multiple responses 311, 312, and 313 may include feedback on the N-th response 313 based on the evaluation criteria related to the N-th response 313 and a feedback score for the N-th response 313 based on the evaluation criteria related to the N-th response 313.

That is, the output of the feedback model 300 may include the feedback on the response of the language model 200 evaluated according to the specified evaluation criteria and the feedback score for the response of the language model 200 predicted according to the specified evaluation criteria.

In an embodiment of the present disclosure, the specified evaluation criteria for a specific task or instruction may be set in advance. In this case, the feedback model 300 may evaluate the response of the language model 200 based on the specified evaluation criteria set, matched, or designated for the specific task, and generate the feedback result for the response of the language model 200 based on the specified evaluation criteria. Therefore, it is possible to evaluate responses for specific tasks by aligning the responses based on a single criterion or aspect.

In an embodiment, when the input data 310 and the multiple responses 311, 312, and 313 include contents related to a mathematical reasoning task, the feedback model 300 may evaluate or analyze each of the multiple responses 311, 312, and 313 according to the first evaluation criterion based on the first evaluation criterion (for instance, logical correctness) set for the mathematical reasoning task, and generate the feedback results for each of the multiple responses 311, 312, and 313 according to the first evaluation criterion based on the evaluation results.

For another embodiment, when the input data 310 and the multiple responses 311, 312, and 313 include contents related to a biographic generation task, the feedback model 300 may evaluate each of the multiple responses 311, 312, and 313 according to the second evaluation criteria based on the second evaluation criteria (for example, factuality) set for the biographic generation task, and generate the feedback results for each of the multiple responses 311, 312, and 313 according to the second evaluation criteria.

In this regard, in an embodiment of the present disclosure, when there is knowledge data or a label to be referenced in the natural language processing (NLP) task, the evaluation performance of the feedback model 300 may be enhanced by using the knowledge data or the label together as the input data of the feedback model 300.

That is, in an embodiment of the present disclosure, the prompts may be generated for each specific task, and the prompts generated for each specific task may include reference data. The prompts for each specific task of the feedback model 300 including such reference data may be configured as in the following example of Table 3.

```
TABLE 3
  Your task is to assess the assistant's response to a question, considering the
given relevant skill.
  [Skill Options]
  {We used the rubric of “Logical Correctness” for mathematical reasoning, and
that of “Factuality” for biography generation.}
  Task 1:
  Briefly describe how acquiring the above necessary skill will help you answer
the question within 1-2 sentences.
  Task 2:
  Request feedback on your assistant's response to the [Instruction] shown below.
In your feedback, please rate the quality of [Answer] according to the scoring criteria
for the required skills above. Please provide feedback only on answers from your
assistant that are marked as [Answer]. For accurate evaluation, we provide [Reference]
that can be used as a reference for evaluating [Answer], which is the assistant's
response to [Instruction]. The scoring criteria for the skill is: ‘−1’ for an answer that
requires improvement, ‘0’ for an answer with room for improvement, and ‘1’ for an
answer that does not require improvement. First provide feedback for that skill and then
write a score for that skill. Please only write feedback that meets the scoring criteria for
that skill. Finally, return a Python dictionary object with the skill name as the key and
the corresponding score (−1, 0, or 1) as the value.
```

Meanwhile, the reward model 400 may be configured to evaluate the quality of the response of the language model 200. The reward model 400 may numerically evaluate the quality of the response of the language model 200 by calculating a preference-based reward score.

Specifically, the reward model 400 may be configured to evaluate the multiple responses 311, 312, and 313 to the input data 310 and assign or provide a reward score to each of the multiple responses 311, 312, and 313.

The reward model 400 may assign different reward scores to each of the multiple responses 311, 312, and 313 based on the evaluation results for each of the multiple responses 311, 312, and 313. For example, as illustrated in FIG. 3, the reward model 400 may assign the reward score to the first response 311 to output a first reward result (e.g., “reward result 1”, 331) including the reward score for the first response 311, assign the reward score to the second response 312 to output a second reward result (e.g., “reward result 2”, 332) including the reward score for the second response 312, and assign the reward score to the N-th response 313 to output an N-th reward result (e.g., “reward result N”, 333) including the reward score for the Nth response 313.

The control unit 160 may acquire or collect the output of the reward model 400 for the multiple responses 311, 312, and 313. For example, the control unit 160 may acquire the first reward result 331, the second reward result 332, and the N-th reward result 333 corresponding to the output of the reward model 400.

Referring to FIG. 2B, in an embodiment of the present disclosure, at step S250, the output of the feedback model and the output of the reward model are stored in the memory, and at step S260, the self-reflection prompt that induces the self-reflection of the language model may be generated using at least one of the output of the feedback model and the output of the reward model stored in the memory.

The control unit 160 may store the output of the feedback model 300 acquired from the feedback model 300 and the output of the reward model 400 acquired from the reward model 400 for the multiple responses 311, 312, and 313, respectively, in the storage unit 140 or memory.

The control unit 160 may generate or construct a training dataset (e.g., a first training dataset D1) including the output of the feedback model 300 and the output of the reward model 400 for the multiple responses 311, 312, and 313 stored in the storage unit 140 or the memory.

For example, as illustrated in FIGS. 2A and 3, the control unit 160 may generate a first training dataset D1 that includes at least one of the input data 310 and the multiple responses 311, 312, and 313, and the output of the feedback model 300 for the multiple responses 311, 312, and 313 and the output of the reward model 400 for the multiple responses 311, 312, and 313 that are stored in the memory. For example, the first training dataset D1 may include the input data 310, the multiple responses 311, 312, and 313, the feedback results 321, 322, and 323 for each of the multiple responses 311, 312, and 313, and the reward scores 331, 332, and 333 for each of the multiple responses 311, 312, and 313.

The first training dataset D1 may be represented as illustrated in (a) of FIG. 9A. The given input or instruction (e.g., input data 310) may be represented as in (b) of FIG. 9A, and the multiple responses 311, 312, and 313 generated for the given input may be represented as in (c) of FIG. 9A. In addition, the output of the reward model 400 may be represented as in (d) of FIG. 9A, and the output of the feedback model 300 may be represented as in (e) of FIG. 9A. The evaluation criteria of the feedback model 300 may be represented as in (f) of FIG. 9A, and the language model 200 may be represented as a policy as in (g) of FIG. 9A.

Furthermore, the control unit 160 may specify at least one of the multiple responses 311, 312, and 313 stored in the memory or included in the first training dataset D1. The control unit 160 may specify at least one of the multiple responses 311, 312, and 313 for the input data 310 based on the predetermined criteria.

Here, the specified response may include at least one promising response specified from the multiple initial responses 311, 312, and 313 to induce the language model 200 to generate a refined response based on the self-reflection or self-reflective feedback.

The predetermined criteria for specifying, determining, or selecting\the promising response may be related to the output of the reward model 400. For example, the predetermined criterion may be related to the highest reward score among the reward or compensation scores assigned to each of the multiple responses 311, 312, and 313 by the reward model 400.

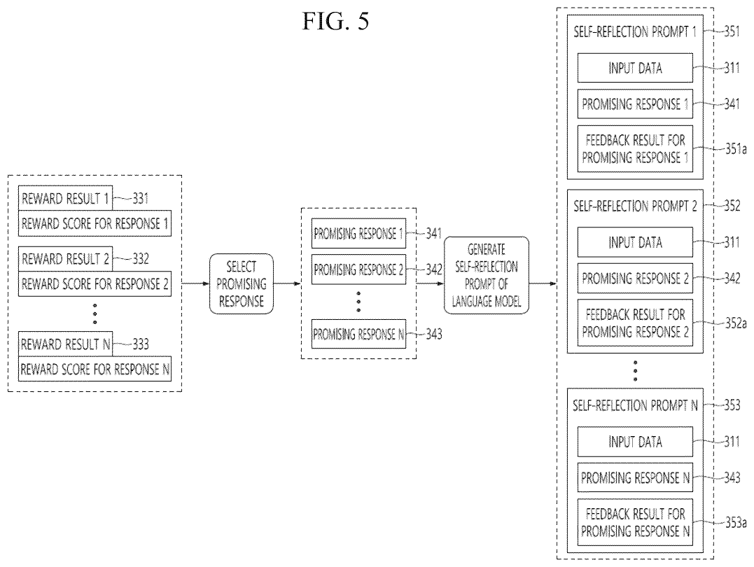

The control unit 160 may specify, determine or select at least one response having the highest reward score among the multiple responses 311, 312, and 313 based on the predetermined criteria. For example, as illustrated in FIG. 5, the control unit 160 may select promising response 341, 342, and 343 having the highest reward score among the multiple responses 311, 312, and 313 using (or based on) the outputs 331, 332, and 333 of the reward model 400. One or more response (e.g. promising response) specified by the reward score may be specified (for example, if there are N or more responses with the same high reward score, N or more may be specified).

The response with the highest reward or the highest reward score may be represented as in (a) of FIG. 9B. Here, N response candidate sets (e.g., the multiple responses 311, 312, and 313) may be represented as in (b) of FIG. 9B, and the feedback for the response 341, 342, and 343 that receive the highest reward or the highest reward score may be represented as in (c) of FIG. 9B.

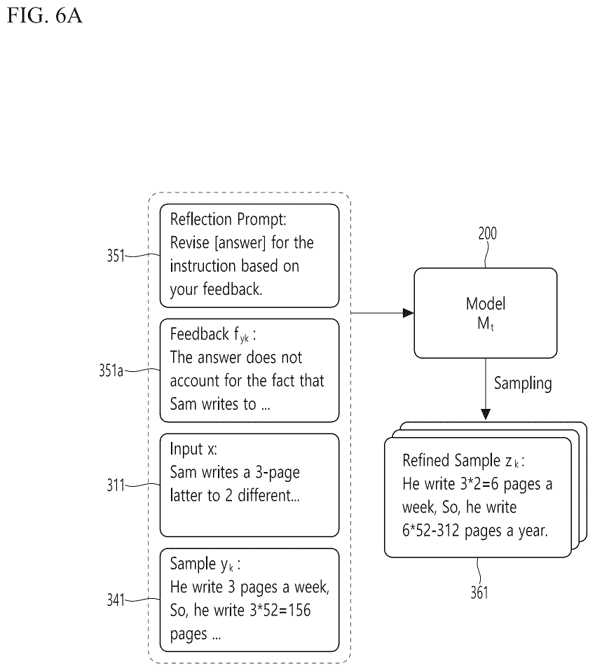

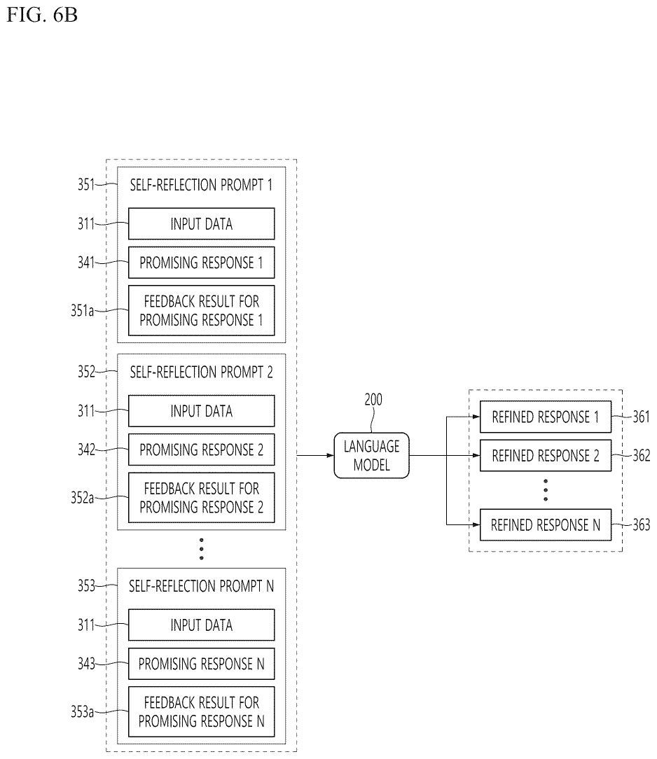

Meanwhile, as illustrated in FIGS. 2 and 6A, in order to generate the refined response through the self-reflection of the language model 200, at least one of a self-reflection prompt 351 that induces the self-reflection, feedback 351a on a specified response, the input data 310, and a specified response 341 may be input to the language model 200.

In this regard, the control unit 160 may generate the self-reflection prompt that induces the self-reflection of the language model 200 using the output of the feedback model 300.

The control unit 160 may collect or acquire a feedback result for the specified response (e.g., promising response) among the feedback results 321, 322, and 323 for each of the multiple responses 311, 312, and 313 corresponding to the output of the feedback model 300 stored in the memory. For example, the control unit 160 may collect feedback results for each of a specified first response (e.g., “promising response 1”, 341), a specified second response (e.g., “promising response 2”, 342), and a specified N-th response (e.g., “promising response N”, 343) as the promising responses among the multiple responses 311, 312, and 313.

The feedback results for the specified responses 341, 342, and 343 may include at least one of feedback on the specified response 341, 342, and 343 according to the evaluation criteria related to the specified response 341, 342, and 343 and feedback scores for the specified response 341, 342, and 343 based on the evaluation criteria.

In an embodiment, when there are multiple specified responses, the feedback on each of the multiple specified responses according to at least one evaluation criterion and the feedback scores for each of the multiple specified responses according to the evaluation criteria may be included.

The control unit 160 may generate the self-reflection prompt (e.g., input prompts 351, 352, 353) to induce the self-reflection of the language model 200 using at least one of the input data 310, the specified responses 341, 342, and 343, and the feedback results for the specified responses 341, 342, and 343.

For example, as illustrated in FIG. 5, the control unit 160 may generate a first self-reflection prompt (e.g., “self-reflection prompt 1”, 351) including the input data 310, a specified first response (e.g., a first promising response 341), and a feedback result 351a for the specified first response 341.

For another example, the control unit 160 may generate a second self-reflection prompt (e.g., “self-reflection prompt 2”, 352) including the input data 310, a specified second response (e.g., a second promising response 342), and a feedback result 352a for the specified second response 342.

For still another example, the control unit 160 may generate an N-th self-reflection prompt (e.g., “self-reflection prompt N”, 353) that includes the input data 310, a specified N-th response (e.g., N-th promising response 343), and a feedback result 353a for the specified N-th response 343.

The self-reflection prompt disclosed above may be configured as in the following example of Table 4.

```
TABLE 4
  [Instruction]
  {Instruction x}
  [Answer]
  {Response yₖ}
  [System]
  {Feedback fᵥ}
  Revise and improve [Answer] for [Instruction] based on your feedback. Your
revision should be simple and clear, so do not add any rhetoric such as an apology for
the past mistake.
  [Revision]
```

Furthermore, referring to FIG. 2G, in an embodiment of the present disclosure, at step S270, the self-reflection prompt is processed as an input to the language model 200, and at step S280, the language model 200 may be fine-tuned using the output result of the language model 200 for the self-reflection prompt.

In an embodiment of the present disclosure, the process of searching for the high-quality response refined through the self-reflection of the language model 200 may also be named “fine-grained self-reflection step”.

The control unit 160 may process the self-reflection prompts 351, 352, and 353 as the input to the language model 200.

When the self-reflection prompts 351, 352, and 353 are input, the language model 200 may perform the self-reflection on the specified response based on the feedback result for the specified response included in the self-reflection prompts 351, 352, and 353 to generate the refined response.

That is, the output of the language model 200 for the self-reflection prompts 351, 352, and 353 may include the refined response generated by refining the specified response through the self-reflection on the specified response based on the self-reflection prompt 351, 352, and 353 in the language model 200.

For example, as illustrated in FIG. 6B, the language model 200 may generate a refined first response (e.g., “refined response 1”, 361) by refining the specified first response 341 through the self-reflection on the specified first response 341 using the feedback result 351a for the specified first response 341 included in the first self-reflection prompt 351.

For another example, the language model 200 may generate a refined second response (e.g., “refined response 2”, 362) by refining the specified second response 342 through the self-reflection on the specified second response 342 using the feedback result 352a for the specified second response 342 included in the second self-reflection prompt 352.

For still another example, the language model 200 may refine the specified N-th response 343 using the feedback result 353a for the specified N-th response 343 included in the N-th self-reflection prompt 353 to generate a refined N-th response (e.g., “refined response N”, 363) through the self-reflection on the specified N-th response 343.

The output result for the refined response from the language model 200 based on the self-reflection prompt may be confirmed by referring to the examples of Tables 5, 6, and 7.

TABLE 5

| | |
|---|---|
| Prompt | [User] Hello |
| | [Assistant] Hello! How may I assist you today? |
| | [User] For this session, I would like you to impersonate |
| | various philosophers |
| Initial | Certainly! I'll do my best to embody the thoughts and |
| Response y from | perspectives of different philosophers throughout history. Please let |
| M₀ | me know which philosophers you'd like me to impersonate and any |
| | specific questions or topics you'd like to discuss. |
| Feedback | Task 1: |
| fₚ | |
| | 1. Skill 4: Insightfulness - This skill is crucial for this |
| | instruction as it requires the model to provide creative and original |
| | responses that embody the thoughts and perspectives of various |
| | philosophers. By enhancing this skill, the model can provide more |
| | insightful and novel responses that accurately represent the |
| | philosophers' views. |
| | 2. Skill 6: Comprehension - The instruction is complex and |
| | requires the model to understand and respond to multiple |
| | requirements. Improving comprehension skills will help the model |
| | to better understand and fulfill the requirements of the instruction. |
| | 3. Skill 7: Readability - The instruction requires the model |
| | to impersonate various philosophers, which means the responses |
| | should be structured in a way that promotes readability and |
| | coherence. Enhancing readability skills will help the model to |
| | provide responses that are easy to understand and follow. |
| | Task 2: |
| | Insightfulness: The response is not particularly insightful or |
| | original. It does not provide any surprising or creative perspectives |
| | or ideas that are challenging to conceive. The response is rather |
| | commonplace and does not showcase significant originality or |
| | novelty. Score: −1 |
| | Comprehension: The model's response is relevant to the |
| | instruction but misses minor requirements of the instruction. The |
| | model did not provide any specific philosophers to impersonate or |
| | any specific questions or topics to discuss. Score: 0 |
| | Readability: The response is generally understandable but |
| | could be further optimized for readability. The model could have |
| | provided more context or examples to make the response more |
| | engaging and coherent. Score: 0 |
| | [{“Insightfulness”: −1, “Comprehension”: 0, “Readability”: |
| | 0}] |
| Self- | Sure! I can act as various philosophers. If you'd like me to |
| refined Response | impersonate Socrates or Plato, we could discuss fundamental |
| z (Selected from | questions such as “What is knowledge?” or “What is justice?” |
| D_{z} | Alternatively, if you prefer Immanuel Kant, we could delve into |
| | philosophical concepts such as the categorical imperative. Or if |
| | you're more interested in the existentialists, we could discuss the |
| | meaning of life, freedom, and human existence. Please pick your |
| | preference! |

TABLE 6

| | |
|---|---|
| Prompt | Boston had 0.5 feet of snow on the first day of winter. The |
| | next day they got additional 8 inches. Over the next 2 days, 2 |
| | inches of the snow melted. On the fifth day, they received |
| | additional 2 times the amount of snow they received on the first |
| | day. How many feet of snow do they now have? |
| Initial | They have a total of 5 feet of snow. |
| Response y from | |
| | Here's the reasoning: |
| M₀ | |
| | 1. On the first day, they received 0.5 feet of snow. |
| (Red- | |
| colored indicates | 2. On the second day, they received 8 inches of snow, |
| incorrect | which is equivalent to 0.67 feet (since there are 12 inches in a foot). |
| generation) | |
| | 3. Over the next 2 days, 2 inches of snow melted, leaving |
| | them with 0.67 + 0.67 = 1.34 feet of snow. |
| | 4. On the fifth day, they received twice the amount of |
| | snow they received on the first day, which is 2 × 0.5 = 1 foot of |
| | snow. |
| | 5. Therefore, they now have 1.34 + 1 = 5 feet of snow. |
| Feedback | Task 1: |
| fₚ | |
| | Acquiring the Logical Correctness skill will enable me to |
| | accurately and efficiently solve mathematical problems, ensuring |
| | that my responses are mathematically correct and logically |
| | consistent. |
| | Task 2: |
| | Feedback on the performance of the response: |
| | The assistant's response contains significant mathematical |
| | inaccuracies. The assistant incorrectly calculates the total amount |
| | of snow after the melt and the additional snowfall on the fifth day. |
| | The correct calculation should have been 6 inches (first day) + 8 |
| | inches (second day) − 2 inches (melt) + 12 inches (fifth day) = 24 |
| | inches, which is 2 feet. The assistant's final answer of 5 feet is |
| | incorrect. |
| | [{“Logical Correctness”: −1}] |
| Self- | They have a total of 2 feet of snow. |
| refined Response | |
| | Here's the reasoning: |
| z (Selected from | |
| D_{z}) | 1. On the first day, they received 6 inches of snow (0.5 |
| | feet). |
| (Refined | |
| response) | 2. On the second day, they received 8 inches of snow. |
| | 3. Over the next two days, 2 inches of snow melted, |
| | leaving 6 + 8 − 2 = 16 inches of snow. |
| | 4. On the fifth day, they received 12 inches of snow, which |
| | is twice the amount they received on the first day. |
| | 5. Therefore, they now have 16 + 12 = 28 inches of snow, |
| | which is 2 feet. |

TABLE 7

| | |
|---|---|
| Prompt | Tell me a bio of Jacqueline MacInnes Wood |
| Initial | Jacqueline MacInnes Wood is a Canadian actress born on |
| Response y from | April 17, 1987. She is widely recognized for her role as Steffy |
| M₀ | Forrester on the CBS soap opera “The Bold and the Beautiful,” |
| | which she has played since 2012. |
| (Red- | |
| colored indicates | Wood's acting career began in her teenage years with roles |
| incorrect | in television shows like “Are You Afraid of the Dark?” and “The |
| generation) | Odyssey.” She also appeared in the film “Final Destination 3” and |
| | had a recurring role on the TV series “Human Target.” |
| | Besides her work on “The Bold and the Beautiful,” Wood |
| | has been involved in other projects such as the TV movie “A |
| | Christmas Prince: The Royal Baby” and the Netflix series “Deadly |
| | Class.” She has received several Daytime Emmy Award |
| | nominations for her performance on “The Bold and the Beautiful.” |
| Feedback | Task 1: |
| fₚ | |
| | Acquiring the skill of Factuality will enable me to provide |
| | information that is accurate and reliable, ensuring that the |
| | biographical details I give about Jacqueline MacInnes Wood are |
| | correct and complete. |
| | Task 2: |
| | Feedback: The response provides a factual and accurate |
| | overview of Jacqueline MacInnes Wood's career, including her role |
| | in “The Bold and the Beautiful,” her early acting roles, and other |
| | projects she has been involved in. However, there are some |
| | inaccuracies and omissions. The response incorrectly states that |
| | Wood has been playing Steffy Forrester since 2012, while she has |
| | been playing the role since 2008. Additionally, the response omits |
| | her Daytime Emmy Awards and her role in “Final Destination 5.” |
| | Therefore, the response is not fully reliable in terms of accuracy. |
| | [{“Factuality”: −1}] |
| Self- | Jacqueline MacInnes Wood is a Canadian actress, |
| refined Response | musician, and television personality born on April 17, 1987. She is |
| z (Selected from | widely known for her portrayal of Steffy Forrester on the CBS soap |
| D_{z}) | opera “The Bold and the Beautiful,” which she has been a part of |
| | since 2008. |
| | Her career began in her teenage years with roles in |
| | television shows like “Are You Afraid of the Dark?” and “The |
| | Odyssey.” Wood's filmography includes a notable appearance in |
| | “Final Destination 5” (2011) and she has hosted the E! series “Party |
| | On” (2013-2014). |
| | For her performance in “The Bold and the Beautiful,” she |
| | has won three Daytime Emmy Awards for Outstanding Lead |
| | Actress in a Drama Series in 2019, 2021, and 2023. Her |
| | contributions to the entertainment industry continue to be |
| | recognized with nominations for her work. |

In an embodiment of the present disclosure, the feedback on the response is provided to the language model 200, and the language model 200 may utilize the self-reflection function to reflect and refine its own response, thereby effectively searching for the high-quality response.

Meanwhile, the control unit 160 may input the input data and the refined response to the input data to the feedback model 300 and the reward model 400, respectively.

As described above, the prompt 410 for the plurality of predetermined evaluation criteria and the refined response may be input to the feedback model 300.

The control unit 160 may acquire the output of the feedback model 300 for the refined response and the output of the reward model 400 for the refined response, respectively.

The output of the feedback model 300 for the refined response may include the feedback result for the refined response. The feedback result for the refined response may include at least one of the feedback and the feedback score for the refined response.

In this regard, the feedback result for each of the multiple refined responses 361, 362, and 363 may include at least one of the feedback on each of the multiple refined responses 361, 362, and 363 according to the specified evaluation criteria and the feedback scores for each of the multiple refined responses 361, 362, and 363 based on the specified evaluation criteria.

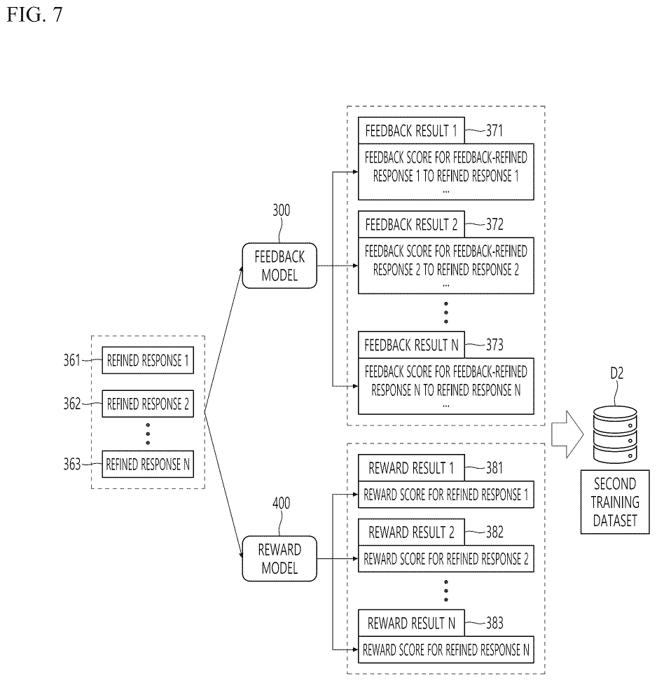

For example, as illustrated in FIG. 7, a first feedback result 371 for the refined first response 361 among the multiple refined responses 361, 362, and 363 may include the feedback on the refined first response 361 based on the evaluation criteria related to the refined first response 361 and a feedback score for the refined first response 361 based on the evaluation criteria related to the refined first response 361.

For another example, a second feedback result 372 for the refined second response 362 among the plurality of refined responses 361, 362, and 363 may include the feedback for the refined second response 362 based on the evaluation criteria related to the refined second response 362 and a feedback score for the refined second response 362 based on the evaluation criteria related to the refined second response 362.

For still another example, an N-th feedback result 373 for the refined N-th response 363 among the plurality of refined responses 361, 362, and 363 may include the feedback for the refined N-th response 363 according to the evaluation criteria related to the refined N-th response 363 and a feedback score for the refined N-th response 363 based on the evaluation criteria related to the refined N-th response 363.

That is, the output of the feedback model 300 for the refined response may include the feedback for the refined response of the language model 200 evaluated according to the specified evaluation criteria and the feedback score for the refined response of the language model 200 predicted according to the specified evaluation criteria.

In addition, the reward model 400 may assign different reward scores to each of the refined responses 361, 362, and 363 based on the evaluation results for each of the refined responses 361, 362, and 363. For example, as illustrated in FIG. 7, the reward model 400 may output a first reward result (e.g., “reward result 1”, 381) including the reward score for the refined first response 361 by assigning the reward score to the refined first response 361, output a second reward result (e.g., “reward result 2”, 382) including the reward score for the refined second response 362 by assigning the reward score to the refined second response 362, and output an N-th reward result (e.g., “reward result N”, 383) including the reward score for the refined N-th response 363 by assigning the reward score to the refined N-th response 363.

Furthermore, the control unit 160 may acquire or collect the output of the feedback model 300 and the output of the reward model 400 for the refined response 361, 362, and 363, and store the acquired output results in the storage unit 140 or memory.

The control unit 160 may generate or construct the training dataset (e.g., a second training dataset) including the output of the feedback model 300 and the output of the reward model 400 for the refined responses 361, 362, and 363 stored in the memory.

More specifically, as illustrated in FIGS. 2A and 7, the control unit 160 may generate a second training dataset D2 that includes at least one of the input data 310 and the plurality of refined responses 361, 362, and 363, and the output of the feedback model 300 for the plurality of refined responses 361, 362, and 363 and the output of the reward model 400 for the plurality of refined responses 361, 362, and 363 that are stored in the memory. For example, the second training dataset D2 may include the input data 310, the multiple refined responses 361, 362, and 363, the feedback results 371, 372, and 373 for each of the multiple refined responses 361, 362, and 363, and the reward scores 381, 382, and 383 for each of the multiple refined responses 361, 362, and 363.

For example, the second training dataset D2 may be represented as in (d) of FIG. 9B. Here, the given input 311, the refined responses 361, 362, and 363, and the feedback for the refined responses 361, 362, and 363 may be represented as in (e) of FIG. 9B. In addition, the refined response 361, 362, and 363 through the self-reflection of the language model 200 may be represented as in (f) of FIG. 9B.

Meanwhile, the control unit 160 may generate the entire dataset to be used for fine-tuning the language model using the first training dataset D1 and the second training dataset D2.

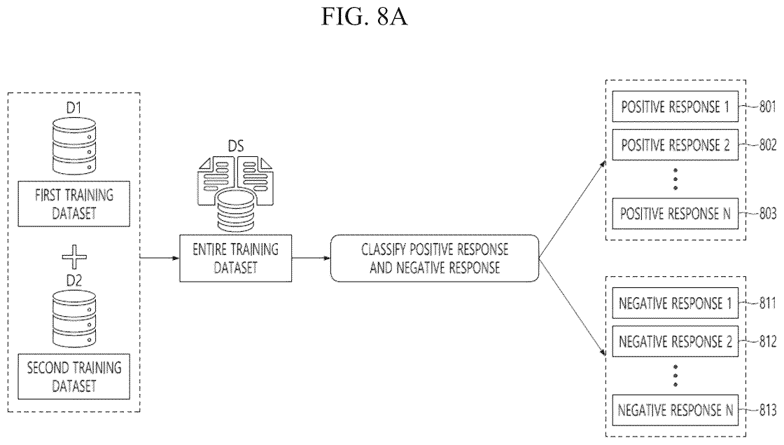

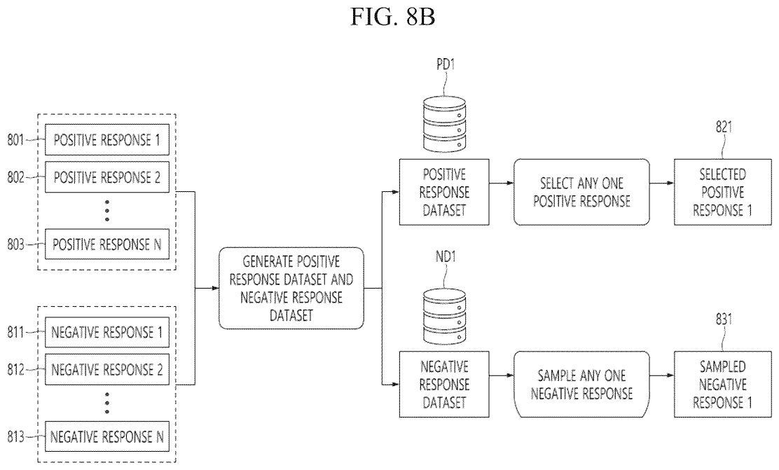

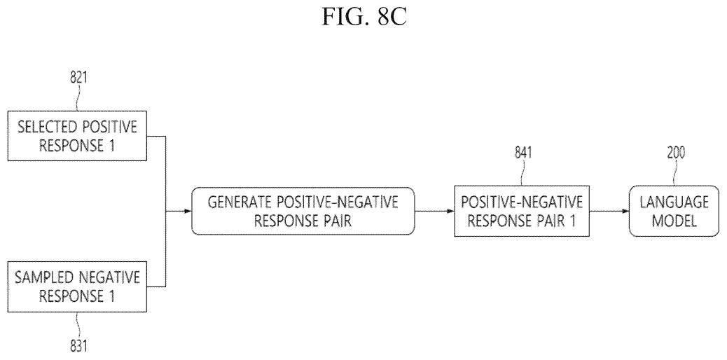

For example, as illustrated in FIG. 8A, the control unit 160 may generate the entire training dataset or a combined training dataset DS by combining the first training dataset D1 and the second training dataset D2. The entire training dataset DS may be represented as in (a) of FIG. 9C.

The control unit 160 may classify positive responses and negative responses from the entire training dataset DS. More specifically, the control unit 160 may classify the multiple response data included in the entire training dataset DS into the positive response and the negative response based on the predetermined classification criteria. For instance, the positive response may be represented as illustrated in (d) of FIG. 9C, and the negative response may be represented as illustrated in (e) of FIG. 9C.

Here, the predetermined classification criteria may be related to the output of the feedback model 300. For example, the predetermined classification criteria may include classifying responses whose feedback scores according to all the evaluation criteria of the feedback model 300 are “1” or higher as the positive responses, and responses whose feedback scores are less than “1” as the negative responses.

When the multiple response data is classified into the positive responses and the negative responses based on the feedback score, the control unit 160 may generate the positive response dataset including the classified positive responses and the negative response dataset including the classified negative responses. For example, as illustrated in FIGS. 8A and 8B, the control unit 160 may generate or construct a positive response dataset PD1 including at least one of positive responses 801, 802, and 803 and a negative response dataset ND1 including at least one of negative responses 811, 812, and 813. For example, the positive response dataset PD1 may be represented as illustrated in (b) of FIG. 9C, and the negative response dataset ND1 may be represented as illustrated in (c) of FIG. 9C.

Furthermore, the control unit 160 may generate data pairs in the form of comparable preferences in order to optimize the policy of the language model 200.

The control unit 160 may generate positive-negative response pairs in which the positive responses and the negative responses are paired by using the positive response dataset PD1 and the negative response dataset ND1.

Specifically, the control unit 160 may specify, determine, or select at least one positive response to be used for generating the positive-negative response pairs from among the positive response dataset PD1 based on the predetermined criteria. In this case, the predetermined criteria may be related to the output of the reward model 400. For example, the predetermined criteria may be related to the response having the highest reward score among the positive responses included in the positive response dataset PD1.

The control unit 160 may specify top k responses (k is a natural number) among the responses that receive the highest reward from the positive response dataset PD1 as the positive responses to be used for generating the positive-negative response pairs based on the predetermined criteria. For example, assume that the reward score of the first positive response 801 is “5”, the reward score of the second positive response 802 is “1”, and the reward score of the third positive response 803 is “5”. The control unit 160 may specify the first positive response 801 and the third positive response 803 in the positive response dataset PD1 as the top k positive responses to be used for generating positive-negative response pairs.

When at least one positive response is determined to be used for generating the positive-negative response pair, the control unit 160 may specify at least one negative response to be used for generating the positive-negative response pair among the negative response dataset ND1. In this case, the control unit 160 may randomly sample or select the negative responses according to the number of positive responses in the negative response dataset ND1 in order to generate the positive-negative response pairs according to a ratio of the specified positive responses.

That is, the negative responses may be sampled in a number corresponding to the number of specified positive responses.

Furthermore, the control unit 160 may generate the positive-negative response pairs in which the positive responses and the negative responses are paired by using any one response 821 selected from the positive response dataset PD1 and any one response 831 sampled in the negative response dataset ND1. For example, as illustrated in FIGS. 8B and 8C, the control unit 160 may generate or configure a first positive-negative response pair 841 in which the specified first positive response 821 and the specified first negative response 831 are paired. The positive-negative response pair may be represented as illustrated in (f) of FIG. 9C.

Meanwhile, the control unit 160 may fine-tune the language model 200 using the positive-negative response pair.

In an embodiment of the present disclosure, the process of fine-tuning the language model 200 may be performed based on the reinforcement learning, and this process may also be named “reinforcement learning step”.

The control unit 160 may fine-tune the language model 200 using the training unit 150. The training unit 150 may define an objective function using the positive-negative response pairs and fine-tune the language model 200 by optimizing the defined objective function. For example, the objective function may be represented as illustrated in (g) of FIG. 9C.

In this way, an embodiment of the present invention may fine-tune the language model 200 by repeatedly performing the self-reflection and the reinforcement learning-based fine-tuning. As the policy of the language model 200 is updated, the language model 200 may generate better responses and improved results in the self-reflection process than the outputs previously generated. In other words, it is possible to achieve the gradual performance improvement of the language model 200 by continuous iterative training until the policy performance of the language model 200 converges. The language model 200 may generate the high-quality responses even in tasks that require factuality or complex reasoning.

As described above, according to some embodiments of the present disclosure, a method and system for large language models alignment may search for high-quality responses among various responses of a language model using a self-reflection mechanism and improve the performance of the language model based on the high-quality responses. The language model may be trained by self-analyzing its own errors and reduce errors using the self-reflection mechanism. Therefore, certain embodiments of the present disclosure may contribute to the intrinsic improvement in performance of the language model, rather than the simple stylistic change, thereby enabling the language model to maintain consistent performance in various tasks (e.g., logical reasoning, document writing, query and response, etc.).

In addition, according to certain embodiments of the present disclosure, a method and system for large language models alignment may evaluate a response of a language model by applying various evaluation criteria through a feedback model, and repeatedly refine the response of the language model based on the feedback results of the feedback model. Hence, some embodiments of the present disclosure may improve the response quality of the language model through the search for the systematic response and provide the environment in which the high-quality responses may be generated. As a result, the language model may generate more accurate and semantically appropriate responses to the input data.

Furthermore, according to some embodiments of the present disclosure, a method and system for large language models alignment may search for various responses of a language model to input data and refine the response of the language model using the output of the feedback model and the output of the reward model for various responses of the language model. Accordingly, by fine-tuning the language model using the refined response based on the output of the feedback model and the output of the reward model, the performance of the language model in various tasks may be improved.

Additionally, according to certain embodiments of the present disclosure, a method and system for large language models alignment may searching for high-quality responses through self-reflection and fine-tune a language model based on responses derived through the self-reflection, thereby improving the downstream performance of the language model as well as contributing to training the more preferred style format. Therefore, the performance of the language model in various tasks may be improved through the excellent flexibility and scalability.

Some embodiments of the present disclosure described above may be executed by one or more processors on a computer and implemented as a program that can be stored on a non-transitory computer-readable medium or recording medium.

Further, certain embodiments of the present disclosure described above may be implemented as computer-readable code or instructions on a medium in which a program is recorded. That is, some embodiments of the present disclosure may be provided in the form of a program.

The computer-readable medium includes all types of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present disclosure, the computer described above is an electronic device equipped with a processor, that is, a central processing unit (CPU), and is not particularly limited to any type.

It should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method for large language models alignment, the method comprising:
generating multiple responses to input data using a language model;
inputting the input data and the multiple responses to the input data to a feedback model and a reward model;
acquiring an output of the feedback model for the multiple responses and an output of the reward model for the multiple responses;
generating a self-reflection prompt that induces self-reflection of the language model using the output of the feedback model for the multiple responses and/or the output of the reward model for the multiple responses;
processing the self-reflection prompt as an input to the language model; and
fine-tuning the language model using an output result of the language model for the self-reflection prompt.

2. The method of claim 1, further comprising specifying at least one of the multiple responses,
wherein the output result of the language model for the self-reflection prompt includes a refined response refined by performing self-reflection on the specified at least one of the multiple responses based on the self-reflection prompt in the language model.

3. The method of claim 2, wherein:
the specifying of at least one of the multiple responses comprises specifying at least one of the multiple responses using the output of the reward model, and
the reward model is configured to evaluate the multiple responses to the input data and assign a reward score to each of the multiple responses.

4. The method of claim 3, wherein:
the output of the reward model includes the reward score assigned to each of the multiple responses, and
the specified at least one of the multiple responses includes a response having a highest reward score among the multiple responses.

5. The method of claim 1, further comprising:
generating a prompt of the feedback model using the input data and the multiple responses; and
processing the generated prompt as an input to the feedback model.

6. The method of claim 5, further comprising evaluating a response of the language model using the prompt of the feedback model which includes a plurality of predetermined evaluation criteria and at least one of the input data or the multiple responses.

7. The method of claim 6, wherein the feedback model is configured to analyze the multiple responses to the input data based on a plurality of evaluation criteria included in the prompt of the feedback model, and generate feedback results for each of the multiple responses based on the analyzing of the multiple responses.

8. The method of claim 7, wherein:
among the plurality of evaluation criteria, the feedback model specifies at least one evaluation criterion related to the input data and each of the multiple responses, and
the feedback model analyzes each of the multiple responses based on the specified at least one evaluation criterion to generate the feedback results for each of the multiple responses.

9. The method of claim 8, wherein:
the output of the feedback model for the multiple responses includes the feedback results for each of the multiple responses, and
the feedback results for each of the multiple responses include at least one of feedbacks for each of the multiple responses based on the specified at least one evaluation criteria or feedback scores for each of the multiple responses according to the specified at least one evaluation criteria.

10. The method of claim 1, wherein the generating of the self-reflection prompt comprises collecting a feedback result for the specified at least one of the multiple responses from among the feedback results for each of the multiple responses corresponding to the output of the feedback model, and generating the self-reflection prompt including at least one of the input data, the specified at least one of the multiple responses, or the feedback result for the specified at least one of the multiple responses.

11. The method of claim 2, wherein the language model generates the refined response by performing the self-reflection on the specified at least one of the multiple responses based on the feedback result for the specified at least one of the multiple responses included in the self-reflection prompt.

12. The method of claim 11, further comprising:
inputting the input data and the refined response to the input data to the feedback model and the reward model; and
acquiring an output of the feedback model for the refined response and an output of the reward model for the refined response.

13. The method of claim 12, wherein the output of the feedback model for the refined response includes a feedback result for the refined response, and the feedback result for the refined response includes a feedback on the refined response and/or a feedback score for the refined response.

14. The method of claim 12, wherein the output of the reward model for the refined response includes a reward score assigned to the refined response.

15. The method of claim 1, further comprising:
generating a first training dataset including one or more of the input data, the multiple responses, the output of the feedback model for the multiple responses, or the output of the reward model for the multiple responses;
generating a second training dataset including one or more of the input data, a refined response, an output of a feedback model for the refined response, or an output of the reward model for the refined response; and
generating an entire training dataset for the fine-tuning of the language model using the first training dataset and the second training dataset.

16. The method of claim 15, further comprising:
classifying the entire training dataset into a positive response and a negative response based on a predetermined classification criterion; and
generating a positive response dataset including the classified positive response and a negative response dataset including the classified negative response.

17. The method of claim 16, further comprising generating a positive-negative response pair where the positive response and the negative response are paired using the positive response dataset and the negative response dataset, and
wherein the language model is fine-tuned using the positive-negative response pair.

18. The method of claim 17, wherein the fine-tuning of the language model comprises defining an objective function using the positive-negative response pair, and performing optimization of the objective function to fine-tune the language model.

19. A system for large language models alignment, comprising:
one or more processors; and
memory configured to store instructions that, when executed by the one or more processors, cause the system to perform operations comprising:
generating multiple responses to input data using a language model;
inputting the input data and the multiple responses to the input data to a feedback model and a reward model,
acquiring an output of the feedback model for the multiple responses and an output of the reward model for the multiple responses,
generating a self-reflection prompt that induces self-reflection of the language model using the output of the feedback model for the multiple responses and/or the output of the reward model for the multiple responses,
processing the self-reflection prompt as an input to the language model, and
fine-tuning the language model using an output result of the language model for the self-reflection prompt.

20. A non-transitory computer-readable storage medium having instructions that, when executed by one or more processors, cause the one or more processors to:
generate multiple responses to input data using a language model;
input the input data and the multiple responses to the input data to a feedback model and a reward model;
acquire an output of the feedback model for the multiple responses and an output of the reward model for the multiple responses;
generate a self-reflection prompt that induces self-reflection of the language model using the output of the feedback model for the multiple responses and/or the output of the reward model for the multiple responses;
process the self-reflection prompt as an input to the language model; and
fine-tune the language model using an output result of the language model for the self-reflection prompt.
